(19) United States
(12) Patent Application Publication
(10) Pub. No.: US 2024/0162580 A1
(43) Pub. Date: May 16, 2024

(54) TERMINAL ASSEMBLY, TOP COVER ASSEMBLY, ENERGY STORAGE DEVICE AND ELECTRICAL EQUIPMENT

(71) Applicants: Shenzhen Hairun New Energy Technology Co., Ltd., Shenzhen (CN); Xiamen Hithium Energy Storage Technology Co., Ltd., Xiamen (CN)

(72) Inventors: Jinyun LIANG, Xiamen (CN); Liangliang ZHANG, Xiamen (CN); Wancai ZHANG, Xiamen (CN); Ming YANG, Xiamen (CN)

(73) Assignees: Shenzhen Hairun New Energy Technology Co., Ltd., Shenzhen (CN); Xiamen Hithium Energy Storage Technology Co., Ltd., Xiamen (CN)

(21) Appl. No.: 18/121,750

(22) Filed: Mar. 15, 2023

(30) Foreign Application Priority Data
Nov. 11, 2022 (CN) 202211416059.X

(51) Int. Cl. H01M 50/553; H01M 50/103; H01M 50/15; H01M 50/176

(52) U.S. Cl. CPC H01M 50/553; H01M 50/103; H01M 50/15; H01M 50/176

(57) ABSTRACT

A terminal assembly, a top cover assembly, an energy storage device and electrical equipment are provided. The terminal assembly has an electrode terminal, an plastic member and a connector. A diametrical dimension of the electrode terminal is D, a minimum radial distance between the connector and the electrode terminal is d, and a maximum radial expansion dimension within a normal use range of the electrode terminal is P, 20≤D/d≤60, 0.01≤P/D≤0.03.

### CROSS-REFERENCE TO RELATED APPLICATION

The application claims priority of Chinese Patent Application No. CN202211416059.X, filed on Nov. 11, 2022, the entire contents of which are incorporated herein by reference for all purposes.

### TECHNICAL FIELD

The present disclosure relates to the technical field of new energy, and in particular, to a terminal assembly, a top cover assembly, an energy storage device and electrical equipment.

### BACKGROUND

As equipment for storing electric energy, an energy storage device can be applied to various kinds of equipment. For example, the energy storage device can be applied to a mobile phone or an electric vehicle. With the prosperity of the mobile phone industry and the electric vehicle industry, the energy storage device industry has also been vigorously developed in recent years.

Generally, the energy storage device includes a top cover assembly. The top cover assembly includes a top cover plate and a terminal assembly, and the terminal assembly includes an plastic member, a connector and an electrode terminal. The electrode terminal is connected with the plastic member, and the connector is connected with the plastic member and the top cover plate respectively to achieve the purpose of fixing the electrode terminal on the top cover plate. The plastic member is used for isolating the electrode terminal from the connector, so as to avoid such a phenomenon that the electrode terminal and the top cover plate are electrically connected to form a short circuit due to the contact between the electrode terminal and the connector.

However, during operation, when the electrode terminal expands, the plastic member will be pressed, and it is easy for the electrode terminal to contact the connector through the plastic member, leading to a failure of the isolation effect of the plastic member. As a result, the electrode terminal and the top cover plate are electrically connected to form a short circuit.

### SUMMARY

The present disclosure discloses a terminal assembly, a top cover assembly, an energy storage device and electrical equipment, which can avoid such a phenomenon that an electrode terminal and a top cover plate are electrically connected to form a short circuit.

In order to achieve at least the above object, in a first aspect, the present disclosure discloses a terminal assembly, including:
an electrode terminal;
an plastic member, surrounding and abutting against at least part of a peripheral surface of the electrode terminal; and
a connector, including a first end portion embedded in the plastic member and a second end portion exposed outside the plastic member, wherein the first end portion and the electrode terminal are spaced apart;
a diametrical dimension of the electrode terminal is D, a minimum radial distance between the connector and the electrode terminal is d, and a maximum radial expansion dimension of the electrode terminal is P during normal usage, so that there is 20≤D/d≤60, 0.01≤P/D≤0.03.

Since the plastic member surrounds and fits at least part of the peripheral surface of the electrode terminal, the electrode terminal can be connected to the plastic member by making the plastic member surround and fit at least part of the peripheral surface of the electrode terminal.

Then, since the first end portion of the connector is embedded in the plastic member, and the second end portion is exposed outside the plastic member, the electrode terminal can be connected to the connector through the plastic member. In addition, since the first end portion and the electrode terminal are spaced apart, when the terminal assembly is applied to the top cover assembly, specifically, when the second end portion is connected to a top cover plate of a top cover assembly, the electrode terminal and the top cover plate can be isolated from each other through the plastic member, thereby avoiding the phenomenon that the electrode terminal and the top cover plate are electrically connected to form a short circuit.

During operation, when the electrode terminal expands, the plastic member will be pressed, so that it is easy for the electrode terminal to contact the connector through the plastic member. When the electrode terminal contacts the connector through the plastic member, the isolation effect of the plastic member will fail. As a result, the electrode terminal and the top cover plate are electrically connected to form a short circuit.

In the embodiment of the present disclosure, the diametrical dimension of the electrode terminal is D, the minimum radial distance between the connector and the electrode terminal is d, and the maximum radial expansion dimension within the normal use range of the electrode terminal is P, and the following conditions are met: 20≤(D/d≤60, 0.01≤(P/D≤0.03. According to inventors' research and experimentation, it has been found that when D/d and P/D are within the above range, when the electrode terminal expands, the phenomenon that the electrode terminal contacts the connector through the plastic member will be avoided, so that the phenomenon that the electrode terminal and the top cover plate are electrically connected to form a short circuit can be avoided.

Optionally, the electrode terminal includes a first disk portion, and a second disk portion arranged on a surface of the first disk portion; the first disk portion and the second disk portion form a step structure together; a peripheral surface of the first disk portion, a peripheral surface of the second disk portion and the surface of the first disk portion connected between the peripheral surface of the first disk portion and the peripheral wall of the second disk portion form the peripheral surface of the electrode terminal, wherein a diametrical dimension of the first disk portion is D1, a diametrical dimension of the second disk portion is D2, where D1>D2.

The first disk portion and the second disk portion form the step structure together, and the peripheral surface of the first disk portion, the peripheral surface of the second disk portion and the surface of the first disk portion connected between the peripheral surface of the first disk portion and the peripheral surface of the second disk portion form the peripheral surface of the electrode terminal, so that the peripheral surface of the entire electrode terminal can substantially form a step structure, and a bonding force between the peripheral surface of the electrode terminal and the plastic member can be increased. Therefore, the electrode terminal is connected to the plastic member more firmly, and the phenomenon that the electrode terminal is separated from the plastic member can be avoided to a certain extent.

Optionally, a minimum radial distance between the connector and the second disk portion is d2, where 40≤D2/d2≤60.

Under the condition of 40≤D2/d2≤60, according to the inventors' research and experimentation, it has been found that when the second disk portion expands, the second disk portion contacts the connector through the plastic member, thus avoiding the phenomenon that the electrode terminal and the top cover plate are electrically connected to form a short circuit.

Optionally, a minimum radial distance between the connector and the first disk portion is d1, where 20≤D1/d1≤40.

In a case of 20≤D1/d1≤40, according to the inventors' research and experimentation, it has been found that when the first disk portion expands, the first disk portion contacts the connector through the plastic member, thus avoiding the phenomenon that the electrode terminal and the top cover plate are electrically connected to form a short circuit.

Optionally, a distance between an end face of the first end portion and the peripheral surface of the first disk portion is d3, where d2<d3.

Since the minimum radial distance between the connector and the second disk portion, that is, the distance between the end face of the first end portion and the peripheral surface of the second disk portion, is less than the distance between the end face of the first end portion and the peripheral surface of the first disk portion, the connector can be roughly formed into a hooked structure, thereby making the connection between the connector and the plastic member firmer.

Optionally, the electrode terminal further includes a third disk portion; the third disk portion is arranged on the second disk portion and protrudes beyond a surface of the plastic member; and a diametrical dimension of the third disk portion is D3, where D3<D2.

The third disk portion is arranged on the second disk portion and protrudes beyond the surface of the plastic member, so that it is convenient to electrically connect the third disk portion to external electrical equipment, which makes the entire electrode terminal easily connected to the electrical equipment, thus avoiding the phenomenon of poor contact between the electrode terminal and the electrical equipment.

Optionally, a diametrical dimension of the plastic member is D4, a diametrical dimension of the second end portion is D5, where 9≤D4/D5≤12.

In a case of 9≤D4/D5≤12, on the one hand, the second end portion will not be too short to make it difficult to connect the second end portion with the top cover plate; and on the other hand, the second end portion will not be too long to cause material waste.

In a second aspect, the present disclosure discloses a top cover assembly, the top cover assembly including:
a top cover plate, provided with an outlet hole; and
the terminal assembly as described any one of in the first aspect, wherein at least part of a projection of the electrode terminal on the top cover plate overlaps the outlet hole, and the second end portion of the connector is connected with the top cover plate.

Since in the terminal assembly, the electrode terminal will not contact the connector through the plastic member, so that the phenomenon that the electrode terminal and the top cover plate are electrically connected to form a short circuit can be avoided. Therefore, when the top cover assembly includes the terminal assembly, the performance of the top cover assembly can be more reliable and short circuit will not occur.

Optionally, the top cover plate is provided with a concave portion, and the second end portion is accommodated in the concave portion and abuts against a bottom of the concave portion; and in an axial direction, a distance from an opening of the concave portion to a top of the second end portion is d4, where 0.1 mm≤d4≤0.7 mm.

In a case of 0.1 mm≤d4≤0.7 mm, on the one hand, partial protrusion caused by the fact that the top of the second end portion axially protrudes beyond the top cover plate can be well avoided; and on the other hand, the phenomenon of a large offset formed between the top of the second end portion and the top cover plate due to an extremely large d4 can also be avoided.

In a third aspect, the present disclosure discloses an energy storage device, the energy storage device including:
a housing, provided with a hole; and
the top cover assembly as described any one of in the second aspect, wherein the top cover plate covers the hole and is adapted for the hole; and the electrode terminal is exposed outside the housing.

Since the performance of the top cover assembly is more reliable and can avoid a short circuit, based on this, when the energy storage device includes the top cover assembly, the performance of the energy storage device can be more reliable.

In a fourth aspect, the present disclosure discloses electrical equipment, including the energy storage device in the third aspect above.

Since the performance of the energy storage device is relatively reliable, when the electrical equipment includes the energy storage device, the performance of the electrical equipment can be more reliable.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a schematic structural diagram of a terminal assembly provided by an embodiment of the present disclosure;

FIG. 2 is an exploded diagram of the terminal assembly in FIG. 1;

FIG. 3 is a sectional view of the terminal assembly in FIG. 1 at the position A-A;

FIG. 4 is a schematic structural diagram of applying the terminal assembly in FIG. 1 to a top cover assembly;

FIG. 5 is a sectional view of another terminal assembly provided by an embodiment of the present disclosure at the position A-A;

FIG. 6 is a partially exploded diagram of a top cover assembly in FIG. 4;

FIG. 7 is a sectional view of the top cover assembly in FIG. 4 at the position B-B; and

FIG. 8 is a schematic structural diagram of an energy storage device provided by an embodiment of the present disclosure.

### DETAILED DESCRIPTION OF EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present disclosure, all other embodiments obtained by those ordinarily skilled in the art without doing creative work shall fall within the protection scope of the present disclosure.

In the present disclosure, the terms “upper”, “lower”, “left”, “right”, “front”, “rear”, “top”, “bottom”, “inner”, “outer”, “middle”, “vertical”, “horizontal”, “transverse”, “longitudinal”, and the like indicate azimuth or positional relationships based primarily on the azimuth or positional relationships shown in the drawings, Not intended to define the indicated device, element or component must have a particular orientation, or be constructed and operated in a particular orientation.

Furthermore, the above-described partial terms may be used in addition to indicating azimuth or positional relationships. It may also be used to refer to other meanings, such as the term “above” in some cases may also be used to refer to certain dependencies or connectivity. The specific meanings of these terms in the present disclosure will be understood by those of ordinary skill in the art as the case may be.

In addition, the terms “mounted”, “disposed”, “provided”, “connected”, “connected”, and “socket” are to be construed broadly to mean, for example, a fixed connection, a detachable connection, or an integral construction. It may be a mechanical connection, or an electrical connection; The specific meaning of the above-mentioned terms in the present disclosure will be understood by those of ordinary skill in the art as the case may be, either directly, or indirectly, via an intermediate medium, or internal communication between two devices, elements, or components.

In addition, the terms “first”, “second”, etc., are used primarily to distinguish different devices, elements or components (the specific type and construction may be the same or different) and are not used to indicate or imply the relative importance or quantity of the indicated device, element or component. Unless otherwise stated, “plurality” means two or more.

The present disclosure is further described below in detail in combination with the accompanying drawings and embodiments.

### EMBODIMENT I

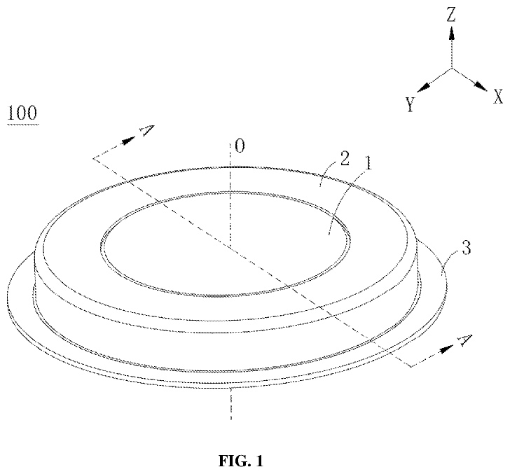

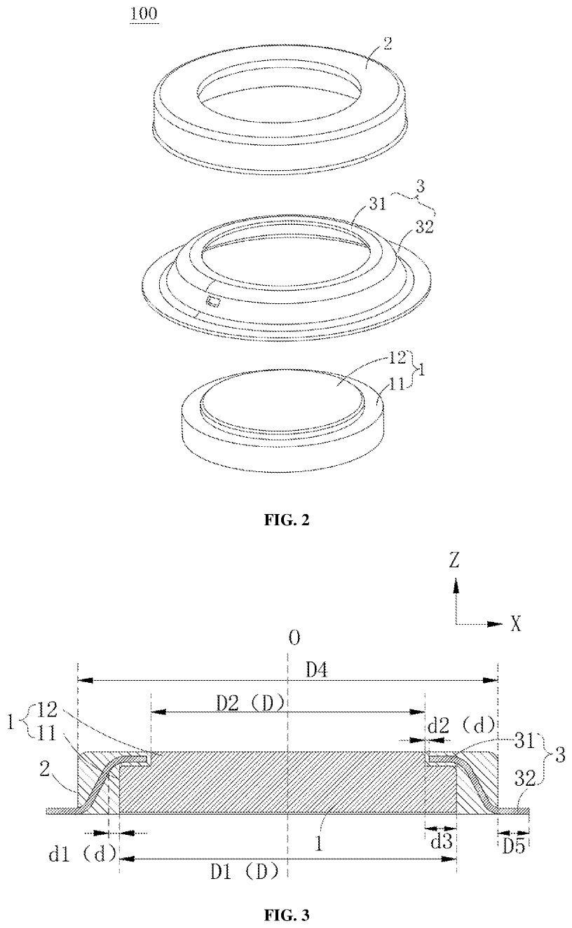

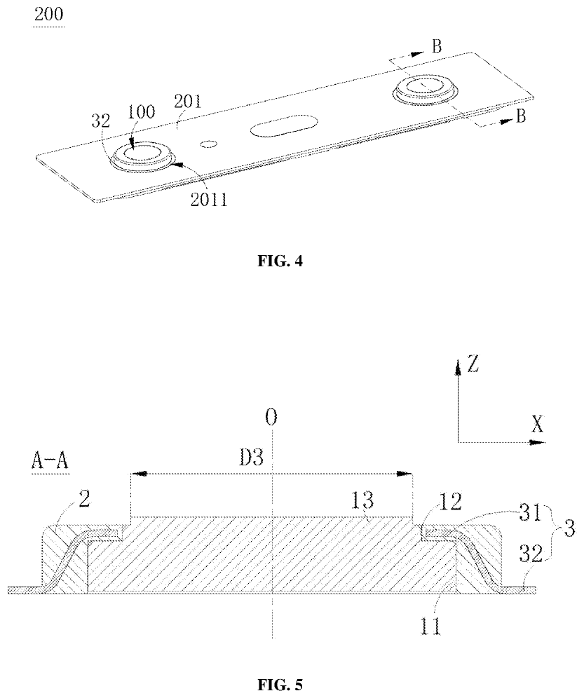

FIG. 1 is a schematic structural diagram of a terminal assembly provided by an embodiment of the present disclosure; FIG. 2 is an exploded diagram of the terminal assembly in FIG. 1; FIG. 3 is a sectional view of the terminal assembly in FIG. 1 at the position A-A; and FIG. 4 is a schematic structural diagram of applying the terminal assembly in FIG. 1 to a top cover assembly.

Referring to FIG. 1, FIG. 2 and FIG. 3, the terminal assembly 100 includes: an electrode terminal 1, an plastic member 2 and a connector 3. The plastic member 2 surrounds and fits at least part of a peripheral surface of the electrode terminal 1. The connector 3 includes a first end portion 31 embedded in the plastic member 2 and a second end portion 32 exposed outside the plastic member 2. The first end portion 31 is spaced apart from the electrode terminal 1. A diametrical dimension (in an X-axis direction in FIG. 3) of the electrode terminal 1 is D, a minimum radial distance between the connector 3 and the electrode terminal 1 is d, and a maximum radial expansion dimension within a normal use range of the electrode terminal 1 is P, so that the following conditions are met: 20≤D/d≤60, 0.01≤P/D≤0.03.

In the embodiment of the present disclosure, since the plastic member 2 surrounds and fits at least part of the peripheral surface of the electrode terminal 1, the electrode terminal 1 can be connected to the plastic member 2 by making the plastic member 2 surround and fit at least part of the peripheral surface of the electrode terminal 1. Then, since the first end portion 31 of the connector 3 is embedded in the plastic member 2, and the second end portion 32 is exposed outside the plastic member 2, the electrode terminal 1 can be connected to the connector 3 through the plastic member 2. In addition, since the first end portion 31 and the electrode terminal 1 are spaced apart, as shown in FIG. 4, when the terminal assembly 100 is applied to the top cover assembly 200, specifically, when the second end portion 32 is connected to a top cover plate 201 of a top cover assembly 200, the electrode terminal 1 and the top cover plate 201 can be isolated from each other through the plastic member 2, thereby avoiding the phenomenon that the electrode terminal 1 and the top cover plate 201 are electrically connected to form a short circuit.

When a battery is in a working state, the electrode terminal 1 will generate heat and expand. When the battery stops working, the electrode terminal 1 will be cooled and shrink back to an original size. The diametrical dimension D in the present disclosure is the original size of the electrode terminal 1 when the battery does not work. The maximum radial expansion dimension P refers to a difference between a dimension of the electrode terminal 1 after expansion and the original size when the battery works. The normal use range of the present disclosure refers to the battery being in a normal working state (generally, the temperature inside the battery does not exceed 60° C.).

When the electrode terminal 1 expands, the plastic member 2 will be pressed, so that it is easy for the electrode terminal 1 to contact the connector 3 through the plastic member 2. When the electrode terminal 1 contacts the connector 3 through the plastic member 2, the isolation effect of the plastic member 2 will fail. As a result, the electrode terminal 1 and the top cover plate 201 are electrically connected to form a short circuit.

In the embodiment of the present disclosure, the diametrical dimension (in the X-axis direction in FIG. 3) of the electrode terminal 1 is D, the minimum radial distance between the connector 3 and the electrode terminal 1 is d, and the maximum radial expansion dimension within the normal use range of the electrode terminal 1 is P, so that there are 20≤D/d≤60, 0.01≤P/D≤0.03. According to inventors' research and experimentation, it has been found that when D/d and P/D are within the above range, when the electrode terminal 1 expands, the phenomenon that the electrode terminal 1 contacts the connector 3 through the plastic member 2 will be avoided, so that the phenomenon that the electrode terminal 1 and the top cover plate 201 are electrically connected to form a short circuit can be avoided. The numerical value of D/d can be any numerical value from 20 to 60, such as 20, 30 or 60, which is not limited in the embodiment of the present disclosure. The numerical value of P/D can be any numerical value from 0.01 to 0.03, such as 0.01, 0.02 or 0.03, which is not limited in the embodiment of the present disclosure.

It should be noted that referring to FIG. 1 and FIG. 3, the radial direction of the electrode terminal 1 refers to a direction perpendicular to and intersecting with axis O of the electrode terminal 1.

It should also be noted that the plastic member 2 surrounds and fits at least part of the peripheral surface of the electrode terminal 1, which refers to that the plastic member 2 surrounds and fits one part of the peripheral surface of the electrode terminal 1 or the plastic member 2 surrounds and fits the entire peripheral surface of the electrode terminal 1.

When the plastic member 2 surrounds and fits the entire peripheral surface of the electrode terminal 1, a connection between the plastic member 2 and the electrode terminal 1 can be firmer.

The above plastic member 2 can be formed by hardening injection molding liquid. In some exemplary embodiments, the above injection molding liquid can be polyphenylene sulfide (PPS) liquid. Of course, the injection molding liquid can also be other kinds of liquid, which is not limited in the embodiment of the present disclosure.

In order to make the connection between the plastic member 2 and the electrode terminal 1 firmer, in some embodiments, referring to FIG. 2 and FIG. 3, the electrode terminal 1 includes a first disk portion 11 and a second disk portion 12 arranged on a surface of the first disk portion 11. The first disk portion 11 and the second disk portion 12 form a step structure together. A peripheral surface of the first disk portion 11, a peripheral surface of the second disk portion 12 and the surface of the first disk portion 11 connected between the peripheral surface of the first disk portion 11 and the peripheral surface of the second disk portion 12 form the peripheral surface of the electrode terminal 1.

The first disk portion 11 and the second disk portion 12 form the step structure together, and the peripheral surface of the first disk portion 11, the peripheral wall of the second disk portion 12 and the surface of the first disk portion 11 connected between the peripheral surface of the first disk portion 11 and the peripheral surface of the second disk portion 12 form the peripheral surface of the electrode terminal 1, so that the peripheral surface of the entire electrode terminal 1 can substantially form a step structure, and a bonding force between the peripheral surface of the electrode terminal 1 and the plastic member 2 can be increased. Therefore, the electrode terminal 1 is connected to the plastic member 2 more firmly, and the phenomenon that the electrode terminal 1 is separated from the plastic member 2 can be avoided to a certain extent.

In some embodiments, referring to FIG. 2 and FIG. 3, if the diametrical dimension of the second disk portion 12 is D2, and the minimum radial distance between the connector 3 and the second disk portion 12 is d2, 40≤D2/d2≤60.

Under the condition of 40≤D2/d2≤60, according to the inventors' research and experimentation, it has been found that when the second disk portion 12 expands, the second disk portion 12 contacts the connector 3 through the plastic member 2, thus avoiding the phenomenon that the electrode terminal 1 and the top cover plate 201 are electrically connected to form a short circuit.

The numerical value of D2/d2 can be any numerical value from 40 to 60. For example, D2/d2 can be 40, 50 or 60, which is not limited in the embodiment of the present disclosure.

In some embodiments, D2/d2=54.3. In a case of D2/d2=54.3, according to the inventors' research and experimentation, it has been found that the phenomenon that the second disk portion 12 contacts the connector 3 through the plastic member 2 can be better avoided.

In some embodiments, 0.27 mm≤d2≤0.67 mm. In a case of 0.27 mm≤d2≤0.67 mm, on the one hand, d2 will not be too large to cause the entire terminal assembly 100 to have an extremely large dimension, and on the other hand, d2 will not be too small to cause the second disk portion 12 to easily contact the connector 3 through the plastic member 2.

For example, d2 can be any numerical value between 0.27 mm and 0.67 mm. For example, d2 can be 0.27 mm, 0.4 mm or 0.67 mm, etc., which is not limited in the embodiment of the present disclosure.

In some embodiments, d2=0.47 mm. In a case of d2=0.47 mm, the dimension of the entire terminal assembly 100 can be reduced to the largest extent while the phenomenon that the second disk portion 12 easily contacts the connector 3 through the plastic member 2. d2 is designed more reasonably.

In some embodiments, referring to FIG. 2 and FIG. 3, 20 mm≤D2≤25 mm. In a case of 20 mm≤D2≤25 mm, on the one hand, the diametrical dimension of the second disk portion 12 can be small to save the material cost of the second disk portion 12; and on the other hand, the diametrical dimension of the second disk portion 12 cannot be too small, thus avoiding the phenomenon of difficulty in machining caused by a too small diametrical dimension of the second disk portion 12.

D2 can be any numerical value within 20 mm≤D2≤25 mm. For example, D2 can be 20 mm, 21 mm or 25 mm, etc., which is not limited in the embodiment of the present disclosure.

Optionally, D2=21.55 mm. In a case of D2=21.55 mm, the material cost of the second disk portion 12 can be saved to the largest extent, and the phenomenon of difficulty in machining caused by a too small diametrical dimension of the second disk portion 12 can be avoided.

In some embodiments, referring to FIG. 2 and FIG. 3, the diametrical dimension of the first disk portion 11 is D1, and the minimum radial distance between the connector 3 and the first disk portion 11 is d1 (roughly shown in FIG. 3), so 20≤D1/d1≤40.

In a case of 20≤D1/d1≤40, according to the inventors' research and experimentation, it has been found that when the first disk portion 11 expands, the first disk portion 11 contacts the connector 3 through the plastic member 2, thus avoiding the phenomenon that the electrode terminal 1 and the top cover plate 201 are electrically connected to form a short circuit.

The numerical value of D1/d1 can be any numerical value from 20 to 40. For example, D1/d1 can be 20, 30 or 40, which is not limited in the embodiment of the present disclosure.

In some embodiments, D1/d1=24.1. In a case of D1/d1=24.1, according to the inventors' research and experimentation, it has been found that the phenomenon that the first disk portion 11 contacts the connector 3 through the plastic member 2 can be better avoided.

In some embodiments, 0.9 mm≤d1≤1.3 mm. In a case of 0.9 mm≤d1≤1.3 mm, on the one hand, d1 will not be too large to cause the entire terminal assembly 100 to have an extremely large dimension, and on the other hand, d1 will not be too small to cause the first disk portion 11 to easily contact the connector 3 through the plastic member 2.

For example, d1 can be any numerical value between 0.9 mm and 1.3 mm. For example, d1 can be 0.9 mm, 1 mm or 1.3 mm, etc., which is not limited in the embodiment of the present disclosure.

Optionally, d1=1.1 mm. In a case of d1=1.1 mm, the dimension of the entire terminal assembly 100 can be reduced to the largest extent while the phenomenon that the first disk portion 11 easily contacts the connector 3 through the plastic member 2. d1 is designed more reasonably.

In some embodiments, 23 mm≤D1≤28 mm. In a case of 23 mm≤D1≤28 mm, on the one hand, the diametrical dimension of the second disk portion 11 can be small to save the material cost of the first disk portion 11; and on the other hand, the diametrical dimension of the first disk portion 11 cannot be too small, thus avoiding the phenomenon of difficulty in machining caused by a too small diametrical dimension of the first disk portion 11.

D1 can be any numerical value within 23 mm≤D1≤28 mm. For example, D1 can be 23 mm, 24 mm or 28 mm, etc., which is not limited in the embodiment of the present disclosure.

Optionally, D1=25.55 mm. In a case of D1=25.55 mm, the material cost of the first disk portion 11 can be saved to the largest extent, and the phenomenon of difficulty in machining caused by a too small diametrical dimension of the first disk portion 11 can be avoided.

In some embodiments, referring to FIG. 2 and FIG. 3, along a radial direction of the electrode terminal 1, if a distance between an end face of the first end portion 31 and the peripheral surface of the second disk portion 12 is d2, and a distance between the end face of the first end portion 31 and the peripheral surface of the first disk portion 11 is d3, there is d2<d3. Since the minimum radial distance between the connector 3 and the second disk portion 12, that is, the distance between the end face of the first end portion 31 and the peripheral surface of the second disk portion 12, is less than the distance between the end face of the first end portion 31 and the peripheral surface of the first disk portion 11, the connector 3 can be roughly formed into a hooked structure, thereby making the connection between the connector 3 and the plastic member 2 firmer.

In some embodiments, referring to FIG. 2 and FIG. 3, an extending direction (the X-axis direction in FIG. 3) of the first end portion 31 towards the peripheral surface of the second disk portion 12 is roughly parallel to the surface of the first disk portion 11.

The extending direction of the first end portion 31 towards the peripheral surface of the second disk portion 12 is roughly parallel to the surface of the first disk portion 11, so that distances between all positions of the first end portion 31 and the surface of the first disk portion 11 can be approximately equal, thus avoiding the phenomenon that the disk surface of the first disk portion 11 contacts all the positions of the first end portion 31 through the plastic member 2.

In some embodiments, referring to FIG. 2 and FIG. 3, the surface of the second disk portion 12 is smoothly connected with a surface of the plastic member 2. The surface of the second disk portion 12 is smoothly connected with the surface of the plastic member 2, so that the structural design of the entire terminal assembly can be relatively regular.

The smooth connection between the surface of the second disk portion 12 and the surface of the plastic member 2 can be understood as follows: The connection between the surface of the second disk portion 12 and the plastic member 2 is smoothly transitioned.

As shown in FIG. 2, both the second disk portion 12 and the first disk portion 11 are of disk structures, and the axis of the second disk portion 12 overlaps the axis of the first disk portion 11. Both the second disk portion 12 and the first disk portion 11 are of disk structures, so that the second disk portion 12 and the first disk portion 11 can be easily machined.

The axis of the second disk portion 12 overlaps the axis of the first disk portion 11, so that the structure of the entire electrode terminal 1 can be more regular facilitating the machining.

It should be noted that when the second disk portion 12 and the first disk portion 11 are both of the disk structures, the diametrical dimension of the second disk portion 12 is D2, which means that the diameter of the second disk portion 12 is D2. Similarly, the diametrical dimension of the first disk portion 11 is D1, which means that the diameter of the first disk portion 11 is D1.

In some embodiments, referring to FIG. 5, the electrode terminal 1 also includes a third disk portion 13. The third disk portion 13 is arranged on the second disk portion 12 and protrudes beyond the surface of the plastic member 2. The diametrical dimension of the third disk portion 13 is D3, where D3<D2. The third disk portion 13 is arranged on the second disk portion 12 and protrudes beyond the surface of the plastic member 2, so that it is convenient to electrically connect the third disk portion 13 to external electrical equipment, which makes the entire electrode terminal 1 easily connected to the electrical equipment, thus avoiding the phenomenon of poor contact between the electrode terminal 1 and the electrical equipment.

The third disk portion 13 can also be of a disk structure, and the axis of the third disk portion 13 overlaps the axis of the second disk portion 12. The third disk portion 13 is of the disk structure, and the axis of the third disk portion 13 overlaps the axis of the second disk portion 12, the third disk portion 13 can be conveniently machined.

In some embodiments, refer to FIG. 2 and FIG. 3, the diametrical dimension of the plastic member 2 is D4, and the diametrical dimension of the second end portion 32 is D5, where 9≤D4/D5≤12.

In a case of 9≤D4/D5≤12, on the one hand, the second end portion 32 will not be too short to make it difficult to connect the second end portion 32 with the top cover plate 201; and on the other hand, the second end portion 32 will not be too long to cause material waste.

9≤D4/D5≤12 can be any value from 9 to 12, for example, D4/D5 can be 9, 10 or 12, etc., which is not limited in the embodiments of the present disclosure.

### EMBODIMENT II

This embodiment of the present disclosure provides a top cover assembly 200. Referring to FIG. 4 and FIG. 6, the top cover assembly 200 includes a top cover plate 201 and a terminal assembly 100. The top cover plate 201 is provided with an outlet hole 2011. At least part of a projection of the electrode terminal 1 on the top cover plate 201 overlaps the outlet hole 2011, and a second end portion 32 of a connector 3 is connected with the top cover plate 201.

The structure of the terminal assembly 100 can be the same as that of any of the terminal assemblies 100 in Embodiment I above, and can bring the same or similar beneficial effects. For details, reference is made to the description of the terminal assembly 100 in the above embodiment, which will not be repeated in this embodiment of the present disclosure.

In this embodiment of the present disclosure, since in the terminal assembly 100, the electrode terminal 1 will not contact the connector 3 through the plastic member 2, so that the phenomenon that the electrode terminal 1 and the top cover plate 201 are electrically connected to form a short circuit can be avoided.

At least part of the projection of the electrode terminal 1 on the top cover plate 201 overlaps the outlet hole 2011, so that the electrode terminal 1 can be exposed outside the outlet hole 2011. In this way, the electrode terminal 1 is conveniently electrically connected to a rolled core inside an energy storage device 300.

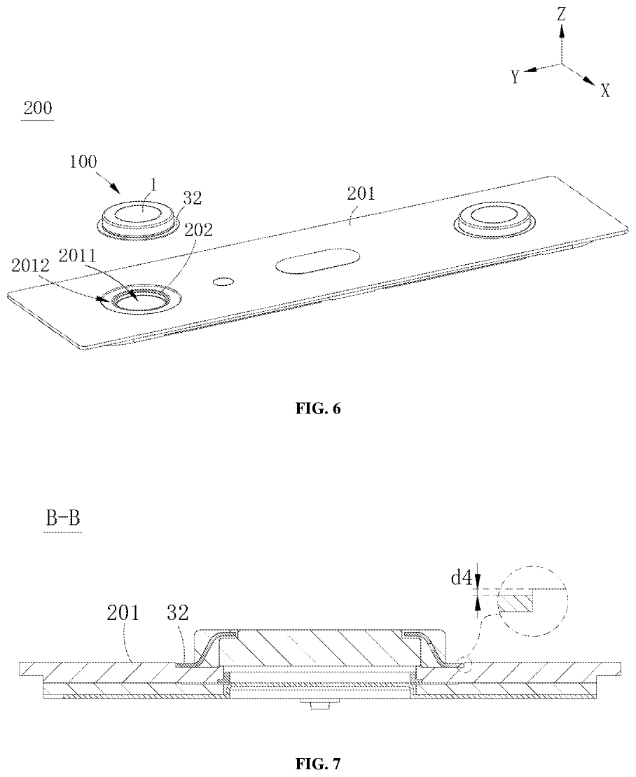

In some embodiments, referring to FIG. 6 and FIG. 7, the top cover plate 201 is provided with a concave portion 2012, and the second end portion 32 is accommodated in the concave portion 2012 and fits a bottom of the concave portion 2012. In an axial direction, a distance from an opening of the concave portion 2012 to a top of the second end portion 32 is d4, so there is 0.1 mm≤d4≤0.7 mm.

In a case of 0.1 mm≤d4≤0.7 mm, on the one hand, partial protrusion caused by the fact that the top of the second end portion 32 axially protrudes beyond the top cover plate 201 can be well avoided; and on the other hand, the phenomenon of a large offset formed between the top of the second end portion 32 and the top cover plate 201 due to an extremely large d4 can also be avoided.

d4 can be any numerical value from 0.1 mm to 0.7 mm. For example, d4 can be 0.1 mm, 0.2 mm or 0.7 mm, etc., which is not limited in the embodiment of the present disclosure.

In some embodiments, referring to FIG. 6, a sealing member 202 is arranged around the outlet hole 2011, and the sealing member 202 is clamped between the top cover plate 201 and the electrode terminal 1. The sealing member 202 is clamped between the top cover plate 201 and the electrode terminal 1, so that on the one hand, overflow of electrolyte in an inner cavity of the energy storage device 300 through the outlet hole 2011 can be avoided. On the other hand, the following phenomenon can also be avoided: During manufacturing of the plastic member 2, liquidous injection molding liquid for making the plastic member 2 enters the inner cavity of the energy storage device.

The sealing member 202 can be a rubber sealing member or a sealing member made of other materials, which is not limited in this embodiment of the present disclosure.

### EMBODIMENT III

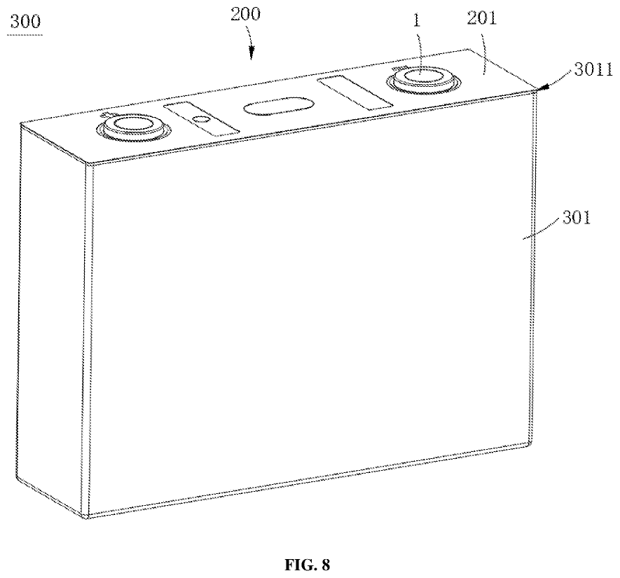

FIG. 8 is a schematic structural diagram of an energy storage device provided by an embodiment of the present disclosure. Referring to FIG. 8, the energy storage device 300 includes a housing 301 and a top cover assembly 200. The housing 301 is provided a hole 3011. The top cover plate 201 covers the hole 3011 and is adapted for the hole 3011. The electrode terminal 1 is exposed outside the housing 301.

The structure of the top cover assembly 200 can be the same as that of any of the top cover assemblies 200 in Embodiment II above, and can bring the same or similar beneficial effects. For details, reference is made to the description of the top cover assembly 200 in Embodiment II, which will not be repeated in this embodiment of the present disclosure.

In this embodiment of the present disclosure, since the performance of the top cover assembly 200 is more reliable and can avoid a short circuit, based on this, when the energy storage device 300 includes the top cover assembly 200, the performance of the energy storage device 300 can be more reliable.

The shape of the housing 301 may be a cuboid, a cube, a cylinder, or the like, which is not limited in this embodiment of the present disclosure.

In addition, the energy storage device 300 can be a cylindrical battery, a square battery, or the like. This embodiment of the present disclosure does not limit the energy storage device 300.

### EMBODIMENT IV

This embodiment of the present disclosure discloses electrical equipment, including any energy storage device 300 in Embodiment III.

The structure of the energy storage device 300 can be the same as that of any of the energy storage devices 300 in Embodiment III above, and can bring the same or similar beneficial effects. For details, reference is made to the description of the energy storage device 300 in Embodiment III, which will not be repeated in this embodiment of the present disclosure.

In this embodiment of the present disclosure, since the performance of the energy storage device 300 is relatively reliable, when the electrical equipment includes the energy storage device 300, the performance of the electrical equipment can be more reliable.

The above electrical equipment can be a new energy vehicle, a hybrid vehicle, or other vehicles, or a mobile phone, a notebook, or other electronic devices.

It should be finally noted that the above various embodiments are only used to describe the technical solutions of the present disclosure, and not intended to limit the present disclosure. Although the present disclosure has been described in detail with reference to the foregoing embodiments, those ordinarily skilled in the art should understand that they can still modify the technical solutions described in all the foregoing embodiments, or equivalently replace some or all of the technical features, and these modifications or replacements do not depart the essences of the corresponding technical solutions from the spirit and scope of the technical solutions of all the embodiments of the present disclosure.

1-20. (canceled)

21. A terminal assembly comprising:
an electrode terminal;
a plastic member, surrounding and abutting against at least part of a peripheral surface of the electrode terminal; and
a connector, comprising a first end portion embedded in the plastic member and a second end portion exposed outside the plastic member, wherein the first end portion and the electrode terminal are spaced apart;
wherein:
a diametrical dimension of the electrode terminal is D, and a minimum radial distance between the connector and the electrode terminal is d;
a maximum radial expansion dimension of the electrode terminal during normal usage is P, wherein 20≤D/d≤60, 0.01≤P/D≤0.03, wherein the diametrical dimension D refers to: an original size of the electrode terminal when the energy storage device is in a non-working state; the maximum radial expansion dimension of the electrode terminal during normal usage refers to: a difference value between a size of the electrode terminal after expansion and the original size when the energy storage device is in a working state and a temperature in the energy storage device is less than or equal to 60° C.;
the electrode terminal comprises a first disk portion and a second disk portion arranged on a surface of the first disk portion; the first disk portion and the second disk portion form a step structure; a peripheral surface of the first disk portion, a peripheral surface of the second disk portion, and a surface of the first disk portion connected between the peripheral surface of the first disk portion and the peripheral surface of the second disk portion form the peripheral surface of the electrode terminal;
a minimum radial distance between the connector and the second disk portion is d2, a minimum radial distance between the connector and the first disk portion is d1, wherein 0.27 mm≤d2≤0.67 mm, 0.9 mm≤d1≤1.3 mm.

22. The terminal assembly according to claim 21, wherein a diametrical dimension of the first disk portion is D1, a diametrical dimension of the second disk portion is D2, wherein D1>D2.

23. The terminal assembly according to claim 22, wherein 40≤D2/d2≤60.

24. The terminal assembly according to claim 22, wherein 20≤D1/d1≤40.

25. The terminal assembly according to claim 23, wherein a distance between an end face of the first end portion and the peripheral surface of the first disk portion is d3, wherein d2<d3.

26. The terminal assembly according to claim 22, wherein:
the electrode terminal further comprises a third disk portion;
the third disk portion is arranged on the second disk portion and protrudes beyond a surface of the plastic member; and
a diametrical dimension of the third disk portion is D3, wherein D3<D2.

27. The terminal assembly according to claim 21, wherein a dimension of the plastic member is D4, and a dimension of the second end portion is D5, wherein 9≤D4/D5≤12.

28. A top cover assembly comprising:
a top cover plate, provided with an outlet hole; and
the terminal assembly according to claim 21,
wherein at least part of a projection of the electrode terminal on the top cover plate overlaps the outlet hole, and the second end portion of the connector is connected with the top cover plate.

29. The top cover assembly according to claim 28, wherein:
the top cover plate is provided with a concave portion, and the second end portion is accommodated in the concave portion and abuts against a bottom of the concave portion; and
in an axial direction, a distance from an opening of the concave portion to a top of the second end portion is d4, wherein 0.1 mm≤d4≤0.7 mm.

30. An energy storage device comprising:
a housing, provided with a hole; and
the top cover assembly according to claim 28, wherein the top cover plate covers the hole and is adapted for the hole; and the electrode terminal is exposed outside the housing.

31. Electrical equipment comprising the energy storage device according to claim 30.
